(19) United States
(12) Patent Application Publication
(10) Pub. No.: US 2026/0121342 A1
(43) Pub. Date: Apr. 30, 2026

(54) CONNECTOR WITH STIFFENERS

(71) Applicant: Molex, LLC, Lisle, IL (US)

(72) Inventors: William J. Miller, II, New Lenox, IL (US); Dennis M. Breen, IV, West Chicago, IL (US); Augusto P. Panella, Naperville, IL (US); Joseph Faia, Fox Lake, IL (US)

(21) Appl. No.: 19/150,206

(22) PCT Filed: Feb. 23, 2023
(86) PCT No.: PCT/IB2024/051750

§ 371 Date: Jul. 23, 2025

Related U.S. Application Data
(60) Provisional application No. 63/449,324, filed on Mar. 2, 2023.

(51) Int. Cl. H01R 13/58; H01R 12/71; H01R 13/405; H01R 13/506

(52) U.S. Cl. CPC H01R 13/582; H01R 13/405; H01R 13/506; H01R 12/716

(57) ABSTRACT

Various aspects of connectors with stiffeners are described. In one example, an electrical connector includes a housing and a wafer assembly positioned within the housing. The housing includes a stiffener, and the wafer assembly includes a terminal row and a cable alignment block. The cable alignment block is seated in the housing over the stiffener. In other aspects, the cable alignment block includes a wafer alignment stake, the stiffener includes a wafer interlock aperture, and the wafer alignment stake extends through the wafer interlock aperture. Because the housing is designed to support the wafer assembly in a position with relative precision, any deformation of the housing may result in an unexpected and unwanted loss of signal coupling integrity. The stiffener helps to reinforce the housing and prevent it from bending or deforming.

### RELATED APPLICATIONS

This application claims the benefit of U.S. Provisional Application No. 63/449,324 filed 2 Mar. 2023. The disclosure of the above-identified application is herein incorporated by reference in its entirety.

### BACKGROUND

The amount of data processed by computers, computing systems, and computing environments continues to increase. For example, data centers can include hundreds of computing and networking systems interconnected using copper cables, optical cables, and various connectors, cable assemblies, and related terminations between them. The data throughput of these interconnects is high and increasing. A range of cable and connector assemblies are available to facilitate the data interconnect applications, such as board-to-board, wire-to-wire, and wire-to-board applications. An example wire-to-board connector assembly includes a free-end connector that is attached to one or more wires or cables and a fixed-end connector that is attached to a board. A wide range of suitable designs exist for each type of data interconnect application, depending on the requirements and the environment in which the cable and connector assemblies are used.

For applications where high data rates are needed and physical space is restricted, competing concerns make the design of cable and connector assemblies more challenging. High data rate applications often rely upon differentially coupled signal pairs in which two conductors are electrically coupled and physically arranged in pairs to transmit a differential signal. Differential signaling provides greater resistance to spurious signals and electronic crosstalk, among other benefits, and preferably maintains sufficient signal spacing to avoid inadvertent signaling modes with adjacent signals pairs. In the connector interface, ground terminals can be added to create a return path to electrical ground and to provide shielding between differential pairs.

Cable and connector assemblies are typically designed to meet both mechanical and electrical requirements. High speed or high data rate electrical connectors are often used, for example, in backplane applications that require very high conductor density and high data rates. To achieve the desired mechanical and electrical requirements, such connectors often incorporate a plurality of wafer assemblies including an insulative web that supports a plurality of electrically conductive terminals. The use of wafer assemblies is often desirable to create a structure capable of achieving the desired high data rate that is also robust enough to support the desired assembly processes.

### SUMMARY

Various aspects of connectors with stiffeners are described. In one example, an electrical connector includes a housing and a wafer assembly. The housing includes a stiffener, and a housing material of the housing can be molded around the stiffener. The wafer assembly includes a terminal row and a cable alignment block. The cable alignment block is seated in the housing over the stiffener. In other aspects, the cable alignment block includes a wafer alignment stake, and the stiffener comprises a wafer interlock aperture. The wafer alignment stake extends through the wafer interlock aperture.

In other examples, the housing also includes a clearance opening, and the wafer interlock aperture of the stiffener is aligned with the clearance opening of the housing, such that a continuous opening extends through the wafer interlock aperture and the clearance opening. The clearance opening is larger than the wafer interlock aperture. The cable alignment block comprises a wafer alignment stake, and the wafer alignment stake extends through the wafer interlock aperture and the clearance opening in one example.

In other aspects, the housing includes a row aperture that extends from a top surface through to a bottom surface of the housing, and the terminal row of the wafer assembly is positioned within the row aperture of the housing. The stiffener comprises an edge stiffener and a wafer interlock stiffer in another example. The edge stiffener is molded into the housing at one side of the row aperture and the terminal row, and the wafer interlock stiffer is molded into the housing at another side of the row aperture and the terminal row.

In other aspects, the housing includes an interlock seat region having an interlock seat surface, at least a portion of a top surface of the stiffener is exposed within the interlock seat region, and the interlock seat surface is substantially coplanar with the top surface of the stiffener that is exposed within the interlock seat region. In other examples, the stiffener includes at least one flow-through aperture with the housing material being molded through the flow-through aperture. In still other examples, the stiffener includes a first sheared end surface at one side of the housing and a second sheared end surface at another side of the housing. The stiffener can also have a top planar surface and a bottom planar surface, where a first region of the top planar surface is exposed outside of the housing material of the housing, and a second region of the top planar surface contacts and is covered by the housing material of the housing.

Another example electrical connector includes a housing and a wafer assembly. The wafer assembly includes a terminal row and a cable alignment block, with the cable alignment block seated in the housing over the stiffener. The cable alignment block includes a wafer alignment stake, the stiffener comprises a wafer interlock aperture, and the wafer alignment stake extends through the wafer interlock aperture. In other aspects, the housing includes a clearance opening, and the wafer interlock aperture of the stiffener is aligned with the clearance opening of the housing, such that a continuous opening extends through the wafer interlock aperture and the clearance opening. The wafer alignment stake extends through the wafer interlock aperture and the clearance opening in one example.

In other aspects, the housing includes a row aperture that extends from a top surface through to a bottom surface of the housing, and the terminal row of the wafer assembly is positioned within the row aperture of the housing. The stiffener includes an edge stiffener and a wafer interlock stiffer. The edge stiffener is positioned at one side of the row aperture and the terminal row, and the wafer interlock stiffer is positioned at another side of the row aperture and the terminal row.

In other aspects, the housing includes an interlock seat region having an interlock seat surface, at least a portion of a top surface of the stiffener is exposed within the interlock seat region, and the interlock seat surface is substantially coplanar with the top surface of the stiffener that is exposed within the interlock seat region. The stiffener comprises a top planar surface and a bottom planar surface in one example. A first region of the top planar surface is exposed outside of the housing, and a second region of the top planar surface contacts and is covered by the housing.

In another example, an electrical connector comprises a lower housing, an upper housing, and a wafer assembly positioned between the lower housing and the upper housing in the connector. The wafer assembly is seated with a stiffener in the connector. The stiffener includes a wafer interlock aperture, and a wafer alignment stake of the wafer assembly extends through the wafer interlock aperture.

In other aspects, the housing includes a clearance opening, and the wafer interlock aperture of the stiffener is aligned with the clearance opening of the housing, such that a continuous opening extends through the wafer interlock aperture and the clearance opening. The wafer alignment stake extends through the wafer interlock aperture and the clearance opening in one example. In another example, the lower housing includes a row aperture that extends from a top surface through to a bottom surface of the housing, and a terminal row of the wafer assembly is positioned within the row aperture of the lower housing. The stiffener comprises an edge stiffener and a wafer interlock stiffer. The edge stiffener is positioned at one side of the row aperture and the terminal row, and the wafer interlock stiffer is positioned at another side of the row aperture and the terminal row.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a perspective view of a connector system according to various embodiments of the present disclosure.

FIG. 2 illustrates a perspective view of the connector system shown in FIG. 1, with the plug connector separated from the receptacle connector, according to various embodiments of the present disclosure.

FIG. 3 illustrates an exploded perspective view of components of the plug connector shown in FIG. 1 according to various embodiments of the present disclosure.

FIG. 4 illustrates a plug wafer assembly and lower housing of the plug connector shown in FIG. 1 according to various embodiments of the present disclosure.

FIG. 5 illustrates a bottom view of the plug connector shown in FIG. 1 according to various embodiments of the present disclosure.

FIG. 6A illustrates a top perspective view of the lower housing of the plug connector in shown in FIG. 1 according to various embodiments of the present disclosure.

FIG. 6B illustrates a top plan view of the lower housing of the plug connector shown in FIG. 1 according to various embodiments of the present disclosure.

FIG. 6C illustrates a bottom plan view of the lower housing shown in FIG. 1 according to various embodiments of the present disclosure.

FIG. 7 illustrates a perspective view of the stiffeners of the lower housing of the plug connector shown in FIGS. 6A-6C according to various embodiments of the present disclosure.

FIG. 8A illustrates a top perspective view of the first wafer assembly shown in FIG. 4 according to various embodiments of the present disclosure.

FIG. 8B illustrates a bottom perspective view of the first wafer assembly shown in FIG. 8A according to various embodiments of the present disclosure.

FIG. 9A illustrates a top perspective view of the second wafer assembly shown in FIG. 4 according to various embodiments of the present disclosure.

FIG. 9B illustrates a bottom perspective view of the second wafer assembly shown in FIG. 9A according to various embodiments of the present disclosure.

FIG. 10A illustrates a side view of the first and second wafer assemblies shown in FIG. 4, separated from each other, according to various embodiments of the present disclosure.

FIG. 10B illustrates a side view of the first and second wafer assemblies shown in FIG. 4 according to various embodiments of the present disclosure.

FIG. 10C illustrates a side view of the first and second wafer assemblies shown in FIGS. 10A and 10B, arranged with stiffeners, according to various embodiments of the present disclosure.

FIG. 11 illustrates a cross-sectional view of the plug connector in the connector system shown in FIG. 1 according to various embodiments of the present disclosure.

FIG. 12 illustrates an enlarged view of part of the cross-sectional view shown in FIG. 11.

### DETAILED DESCRIPTION

As noted above, cable and connector assemblies are typically designed to meet both mechanical and electrical requirements. To achieve the desired mechanical and electrical requirements, such connectors often incorporate a plurality of wafer assemblies that support a plurality of electrically conductive terminals. The wafer assemblies are typically enclosed and supported by connector housings, and a range of sizes, shapes, and styles of connector housings are available for different interconnect applications.

An example wire-to-board connector assembly includes a free-end connector that is attached to one or more wires or cables and a fixed-end connector that is attached to a board. When inserted into the fixed-end connector, the free-end and fixed-end connectors can exert forces upon each other, and the housings of both the fixed-end and the free-end connectors may experience a range of forces and stresses. Additionally, depending upon the type (e.g., gauge, size, weight, etc.) and manner in which cables or wires are coupled to a free-end connector, the cables or wires may inadvertently act as a type of lever, presenting certain forces on the free-end connector and, in some cases, the fixed-end connector. Over time, such forces can cause the connectors and connector housings to bend, deform, and possibly crack or break at certain locations. Any loss of structural integrity due to damage in connector housings may translate to loss of signal coupling integrity through the associated connector. The housings are designed to support wafer assemblies in a precise and controlled manner by design. Thus, damage to or deformation of connector housings may result in the application of unwanted, undesirable, and unexpected forces being presented on the wafer assemblies within the housings, which can result in an unexpected and unwanted loss of signal coupling integrity.

In the context outlined above, a number of connectors with stiffeners are described herein. In one example, an electrical connector includes a housing and a wafer assembly positioned within the housing. The housing includes a stiffener, and the wafer assembly includes a terminal row and a cable alignment block. The cable alignment block is seated in the housing over the stiffener. In other aspects, the cable alignment block includes a wafer alignment stake, the stiffener includes a wafer interlock aperture, and the wafer alignment stake extends through the wafer interlock aperture. Because the housing is designed to support the wafer assembly in a position with relative precision, any deformation of the housing may result in an unexpected and unwanted loss of signal coupling integrity. The stiffener helps to reinforce the housing and prevent it from bending or deforming.

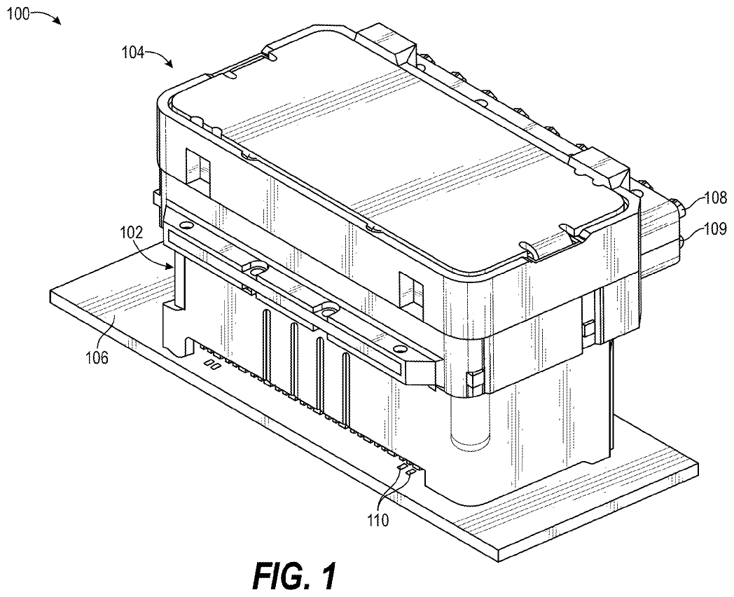

Turning to the drawings, FIG. 1 illustrates a perspective view of a connector system 100 according to various embodiments of the present disclosure. The connector system 100 is an example of a wire-to-board system, although the concepts described herein are not limited to wire-to-board connector systems or any particular type or style of interconnect system. The connector system 100 includes a plug connector 104 and a receptacle connector 102 in the example shown, and the receptacle connector 102 is mounted to a substrate 106.

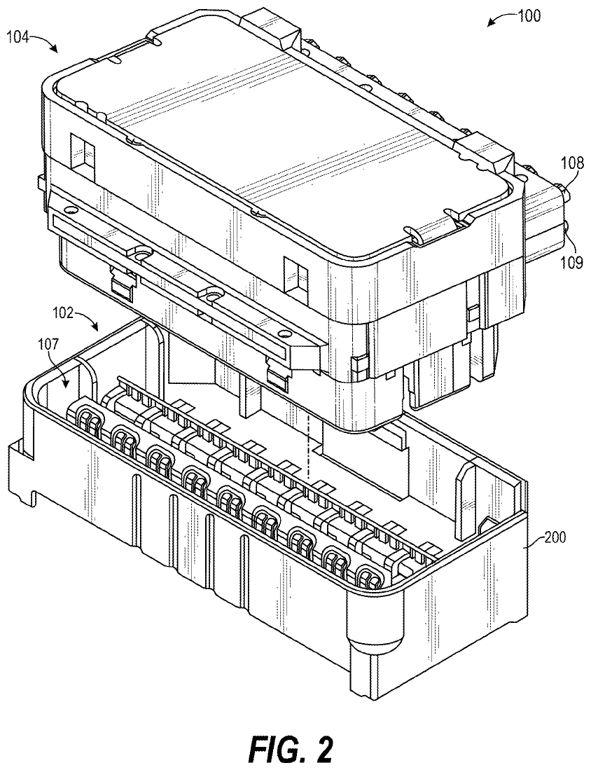

The plug connector 104 mates with the receptacle connector 102 as would be understood in the field. Electrical couplings or connections are made between terminals within the receptacle connector 102 and terminals within the plug connector 104, when mated together, as described herein. The connector assembly 100 is designed to permit the plug connector 104 to be mated with the receptacle connector 102, as shown in FIG. 1, and also for the plug connector 104 to be releasable from the receptacle connector 102, as shown in FIG. 2. Thus, the plug connector 104 mates with and releases from the receptacle connector 102 to facilitate assembly and interchangeability of electrical components to which the plug connector 104 and receptacle connector 102 are operatively associated with.

The substrate 106 can be embodied as printed circuit board (PCB), a backplane board, or another substrate having electrically conductive traces connected to conductive pads 110 on a mounting surface of the substrate 106. A number of cables, such as the cables 108 and 109 are terminated, at one end, within the plug connector 104. Electrical signals conducted through the cables 108 and 109, among others, are electrically coupled from the cables 108 and 109, through wafer assemblies in the plug connector 104, through wafer assemblies in the receptacle connector 102, and ultimately to the conductive pads 110 and traces on the substrate 106. In one example, the receptacle connector 102 can be embodied, in at least some aspects, as that shown and described in U.S. Pat. No. 11,495,909 (“the '909 Patent”), the entire contents of which is hereby incorporated herein by reference. The plug connector 104 can also be embodied, in at least some aspects, as the plug connector shown and described in the '909 Patent. The plug connector 104 is different than that described in the '909 Patent and other connectors known in the field, however, according to the concepts described herein.

FIG. 2 illustrates a perspective view of the connector system 100 shown in FIG. 1, with the plug connector 104 separated from the receptacle connector 102. The plug connector 104 includes a housing 300, and the receptacle connector 102 includes a housing 200. Wafer assemblies are positioned and secured within the housing 200 and the housing 300. For example, terminal rows 107 of receptacle wafer assemblies are illustrated in FIG. 2. Mating terminal rows of plug terminal wafers are positioned within the housing 300, although they are not visible in FIG. 2. When the plug connector 104 is inserted into the receptacle connector 102, the terminal rows contact each other and facilitate an electrical connection or coupling between the terminal rows and wafers.

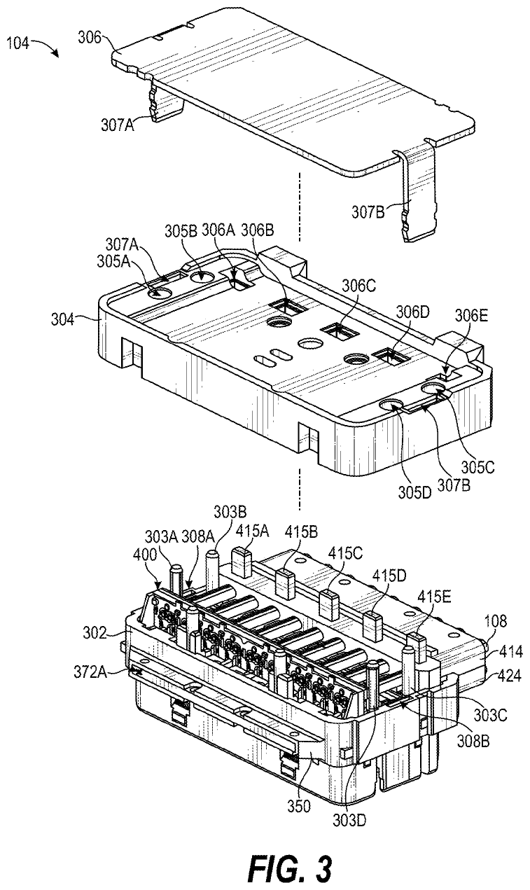

FIG. 3 illustrates an exploded perspective view of components of the plug connector 104 shown in FIG. 1 according to various embodiments of the present disclosure. As shown, the housing 300 of the plug connector 104 includes a lower housing 302, upper housing 304, and a housing clip 306. A plug wafer assembly 400 is positioned within the lower housing 302. The upper housing 304 can be seated upon the lower housing 302, to enclose the plug wafer assembly 400 within the plug connector 104. In that arrangement, the housing clip 306 can also be positioned over a top of the upper housing 304. Interlock arms 307A and 307B of the housing clip 306 extend through apertures in the upper housing 304 and the lower housing 302, securing and maintaining the housing 300 of the plug connector 104 together, as described in additional detail below.

The lower housing 302 can be embodied by a molded plastic or polymer material in one example, although other suitable materials may be relied upon. The upper housing 304 can also be embodied by a molded plastic or polymer material in one example, although other suitable materials may be relied upon. The lower housing 302 includes a number of stiffeners according to aspects of the embodiments. In one example, the lower housing 302 includes insert-molded stiffeners, although it is not necessary that the stiffeners and the concepts of structural supports for connector housings be molded or insert-molded into the housings of connectors. In some cases, the stiffeners described herein can also be assembled into housings for connectors using press- or interference-fits, mechanical interlocks, fasteners, or other arrangements. It is also not necessary for the housings described herein to be molded. The housings can also be formed or manufactured through additive or subtractive manufacturing processes and other approaches known the field. The housing clip 306 can be stamped or sheared from a metal or metal alloy material sheet and bent into shape or form, in one example.

A number of positioning and interlocking features of the lower housing 302, the plug wafer assembly 400, and the upper housing 304 maintain the components of the plug connector 104 in alignment with each other. For example, the lower housing 302 includes alignment projections or pins 303A-303D, among possibly others. Corresponding to those projections or pins, the upper housing 304 includes alignment apertures 305A-305D. When the upper housing 304 is assembled with the lower housing 302, the projections or pins 303A-303D extend into the alignment apertures 305A-305D, with only a minimal or nominal clearance, if any, between them.

Additionally, the plug wafer assembly 400 includes wafer alignment posts 415A-415E. Corresponding to those alignment posts, the upper housing 304 includes wafer alignment apertures 306B-306E. When the upper housing 304 is assembled with the lower housing 302, the wafer alignment posts 415A-415E extend into the wafer alignment apertures 306B-306E, with only a minimal or nominal clearance, if any, between them. Further, the interlock arms 307A and 307B of the housing clip 306 extend through apertures 308A and 308B, respectively, in the upper housing 304 and through apertures 308A and 308B, respectively, in the lower housing 302, securing and maintaining the housing 300 of the plug connector 104 together. These and possibly other features help to maintain and fix the positions of the lower housing 302, the upper housing 304, and the plug wafer assembly 400 with respect to each other, when the plug connector 104 is assembled.

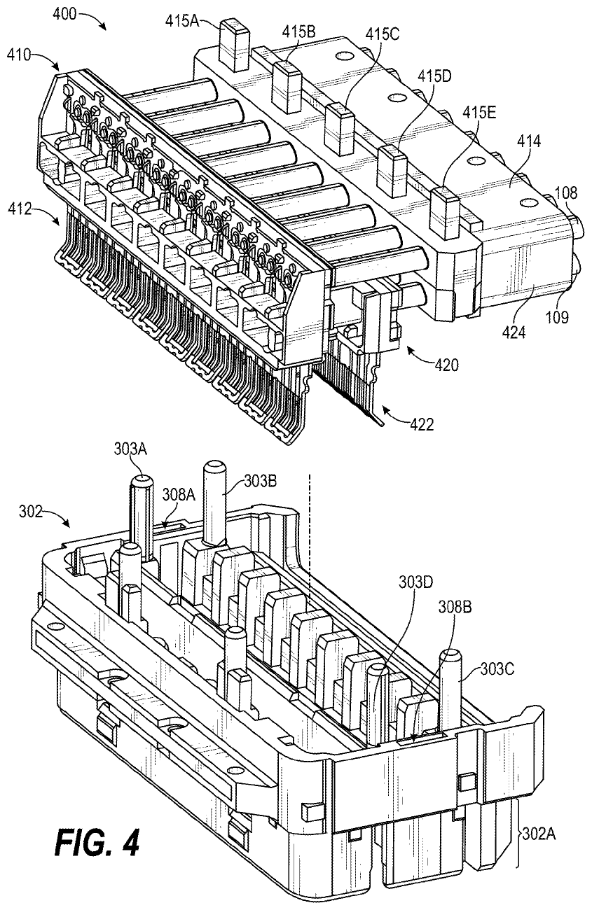

FIG. 4 illustrates the plug wafer assembly 400 and lower housing 301 of the plug connector 104 shown in FIG. 1. The plug wafer assembly 400 includes a first wafer assembly 410 and a second wafer assembly 420. The first wafer assembly 410 includes a terminal row 412, and the second wafer assembly 420 includes a terminal row 422. The first wafer assembly 410 also includes a cable alignment block 414, and the second wafer assembly 420 also includes a cable alignment block 424. In one example, the first wafer assembly 410 can be similar to that shown in the '909 Patent, although the embodiments described herein are not limited to use with a particular type or style of wafer assembly or assemblies. The second wafer assembly 420 can also be similar to that shown in the '909 Patent, in one example, although the embodiments described herein are not limited to use with a particular type or style of wafer assembly or assemblies.

The cable alignment blocks 414 and 424 can be molded or otherwise formed from a plastic or polymer material, in one example. The cable alignment blocks 414 and 424 help to position and align the cables 108 and 109, among others, that are terminated at the plug wafer assembly 400. The cables 108 and 109 can be embodied as twinaxial cables, in one example, each including a pair of signal conductors and a ground or common conductor. The signal and ground conductors are electrically coupled to and terminated at the first and second wafer assemblies 410 and 420. Electrical signals propagating on the signal conductors are electrically coupled to signal pins or terminals in the terminal row 412 and the terminal row 422. Similarly, the ground conductors are electrically coupled to ground terminals in the terminal row 412 and the terminal row 422.

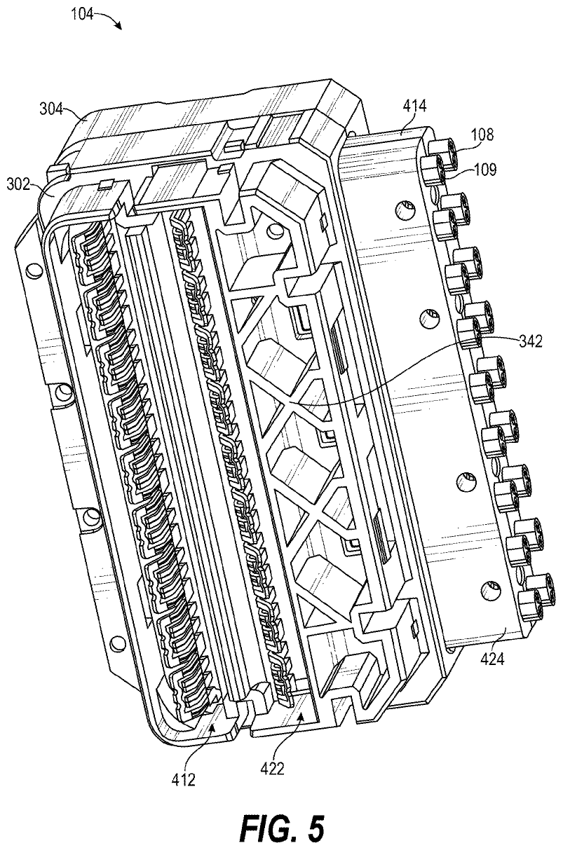

FIG. 5 illustrates a bottom view of the plug connector 104 in the connector system 100 shown in FIG. 1. As shown in FIG. 5, the terminal rows 412 and 422 extend within the lower housing 302 when the plug connector 104 is assembled. The terminal rows 412 and 422 are positioned to electrically contact and mate with the terminal rows 107 in the receptacle connector 102, which is shown in FIG. 2, when the plug connector 104 is inserted into the receptacle connector 102.

When the plug connector 104 is inserted into the receptacle connector 102, the plug connector 104 and the receptacle connector 102 impart a range of forces upon each other. The lower housing 302, for example, may be subjected to bending, pulling, twisting, and other forces due to a variety of factors. Additionally, the cables 108 and 109, which are flexible and may be elastic, can impart forces upon the plug connector 104 due to the elastic nature of the cables 108 and 109. The cables 108 and 109 may also inadvertently act as a type of lever, translating forces to the plug connector 104, the receptacle connector 102, or both. Over time, such forces can cause the lower housing 302 of the plug connector 104, for example, to bend, deform, and possibly crack or break at certain locations. Any loss in structural integrity or rigidity of the lower housing 302 may translate to loss of signal coupling integrity through the plug wafer assembly 400.

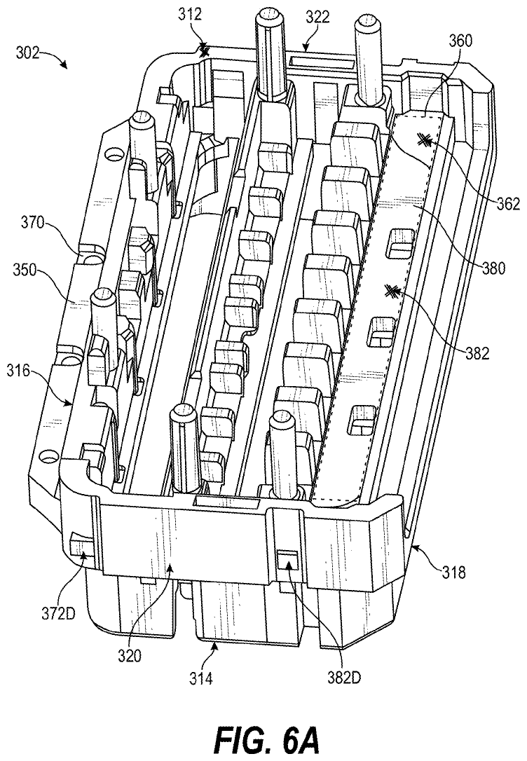

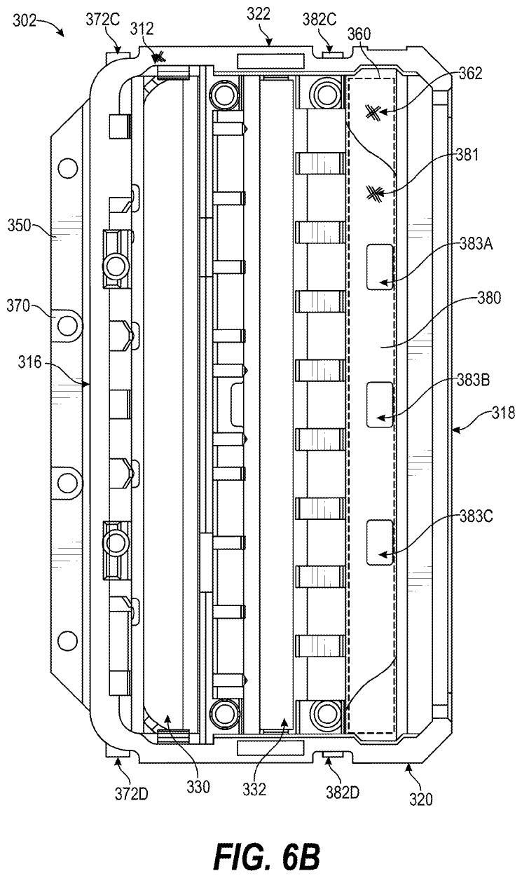

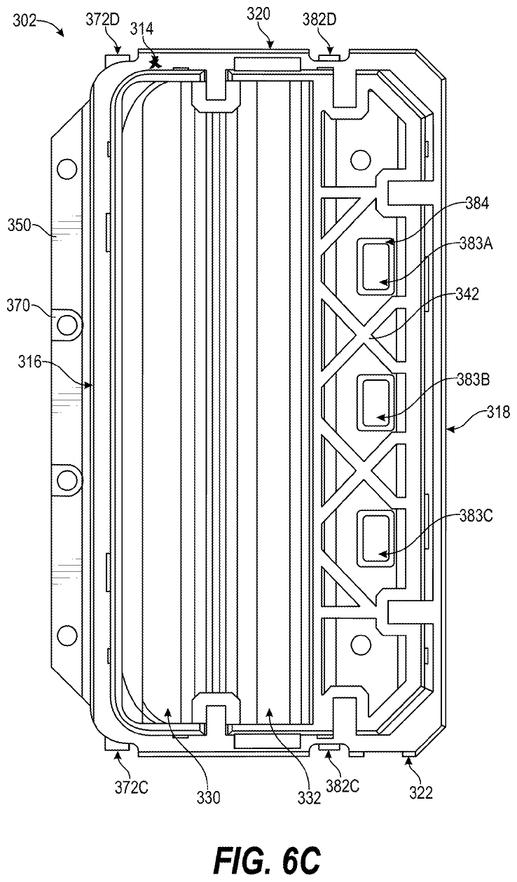

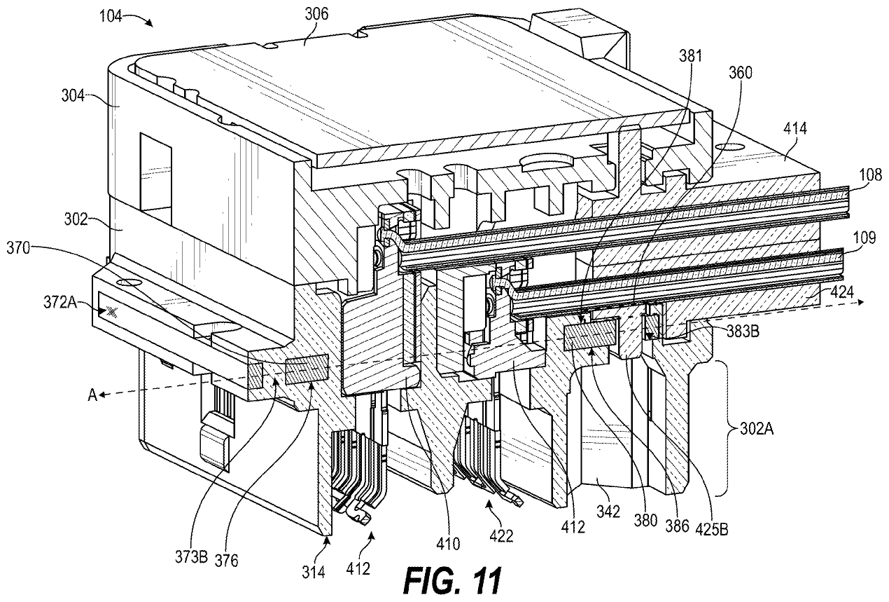

According to aspects of the embodiments, the connector system 100 includes a range of features to help maintain strength and structural integrity, even in the presence of external forces over time. As one example, the lower housing 302 includes a reinforcement truss 342 (see FIG. 5). The reinforcement truss 342 provides additional strength for the sidewalls of the insertion region 302A (see FIG. 3) of the lower housing 302. The reinforcement truss 342 is integrally formed in the insertion region 302A, below an interlock seat region 360 (see FIGS. 6B and 11) for the cable alignment blocks 414 and 424 in the lower housing 302, as described in further detail below. The lower housing 302 also includes a number of stiffeners, which can be insert-molded into the lower housing 302 in one example. These and other aspects of the embodiments are described in further detail below.

FIG. 6A illustrates a top perspective view, FIG. 6B illustrates a top plan view, and FIG. 6C illustrates a bottom plan view of the lower housing 302 of the plug connector 104 according to various embodiments of the present disclosure. Referring among FIGS. 6A-6C, the lower housing 302 includes a top surface 312, a bottom surface 314, a front surface 316, a rear surface 318, a first side surface 320, and a second side surface 322, among other external surfaces.

Referring to FIGS. 6B and 6C, the lower housing 302 includes terminal row apertures 330 and 332. The terminal row apertures 330 and 332 extend from the top surface 312 through to the bottom surface 314 of the lower housing 302. The terminal rows 412 and 422 of the plug wafer assembly 400 extend through and within the terminal row apertures 330 and 332, when the plug connector 104 is fully assembled. The lower housing 302 also includes a support ledge 350, which extends out from and beyond the front surface 316. A stiffener 370 is positioned and molded into the support ledge 350, in part, and into the main body of the lower housing 302. Additional features of the stiffener 370 and the manner in which the stiffener 370 is incorporated with the lower housing 302 are described below.

The lower housing 302 also includes an interlock seat region 360. The cable alignment blocks 414 and 424 of the plug wafer assembly 400 can be inserted, positioned, and seated into the interlock seat region 360. In that arrangement, the cable alignment blocks 414 and 424 rest in part upon the interlock seat surface 362. The lower housing 302 also includes a stiffener 380, and a top surface 381 of the stiffener 380 is exposed over a region of the interlock seat surface 362. The top surface 381 of the stiffener 380 is substantially coplanar with the interlock seat surface 362 in the interlock seat region 360. Thus, the cable alignment blocks 414 and 424 of the plug wafer assembly 400 can be seated in part upon the top surface 381 of the stiffener 380, as shown in the cross-sectional view of FIG. 11 described below, as well as upon the interlock seat surface 362. Additional features of the stiffener 380 and the manner in which the stiffener 380 is incorporated with the lower housing 302 are described below. In other designs, one of the stiffeners 370 and 380 can be omitted from the housing 302.

As also shown in FIG. 6C, the lower housing 302 includes a reinforcement truss 342. The reinforcement truss 342 provides additional strength for the sidewalls of the insertion region 302A (see FIG. 3) of the lower housing 302. The reinforcement truss 342 can be integrally formed in the insertion region 302A by molding, below the interlock seat region 360. The reinforcement truss 342 may include overlapping cross-members within the insertion region 302A, forming delta- and x-shaped regions.

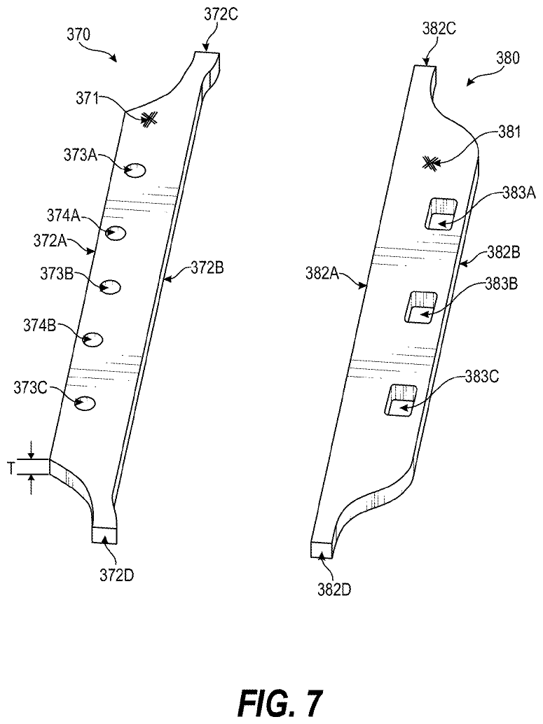

FIG. 7 illustrates a perspective view of the stiffeners 370 and 380 of the lower housing 302, separate from the lower housing 302. The stiffeners 370 and 380 are illustrated as representative examples of structural stiffeners or reinforcing members for the lower housing 302. The stiffeners 370 and 380 can range in size, shape, and format as compared to that shown in various embodiments. For example, the stiffeners 370 and 380 can be larger or smaller, formed in other shapes, include apertures at other positions, and include additional or omit certain features as compared to that shown.

The stiffener 370 includes a top surface 371 and an opposite-facing bottom surface 376 (see FIG. 11). The top surface 371 is planar, and the bottom surface 376 is also planar in the example shown. The top surface 371 extends in a plane that is parallel to a plane in which the bottom surface 376 extends. The stiffener 370 also includes a front surface 372A, a back surface 372B, a first side surface 372C, and a second side surface 372D. The front surface 372A and the back surface 372B includes curves or curved portions in the example shown. The surfaces of the stiffener 370 are largely enclosed or covered within the lower housing 302, when the lower housing 302 is formed. The front surface 372A of the stiffener 370 is exposed along the support ledge 350, however, as best shown in FIG. 3. The stiffener 370 can also be referenced as an edge stiffener, as it is exposed along the support ledge 350 of the lower housing 302, on an exterior edge of the lower housing 302.

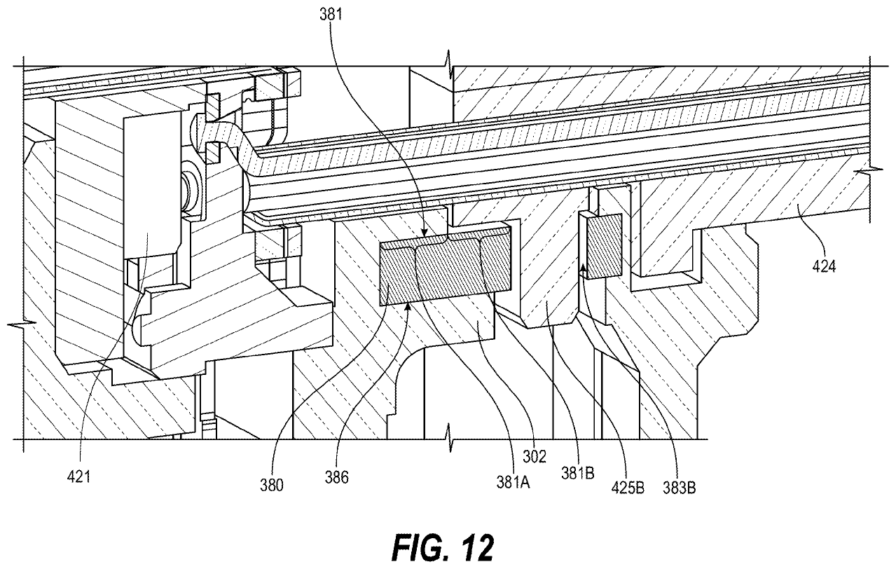

The stiffener 380 includes a top surface 381 and an opposite-facing bottom surface 386 (see FIG. 11). The top surface 381 is planar, and the bottom surface 386 is also planar in the example shown. The top surface 381 extends in a plane that is parallel to a plane in which the bottom surface 386 extends. The stiffener 380 also includes a front surface 382A, a back surface 382B, a first side surface 382C, and a second side surface 382D. The front surface 382A is substantially flat, and the back surface 372B includes curves or curved portions in the example shown. Many surfaces of the stiffener 380 are enclosed or covered within the lower housing 302, when the lower housing 302 is formed. However, at least a portion 381B (see FIG. 12) of the top surface 381 of the stiffener 380 is exposed over a region of the interlock seat region 360. This exposed portion of the top surface 381 is substantially coplanar with the interlock seat surface 362 in the interlock seat region 360 (see FIG. 6A) when the lower housing 302 is formed. The stiffener 380 can also be referenced as a wafer interlock stiffer, as it helps to secure the plug wafer assembly 400 in place, within the plug connector 104.

The stiffeners 370 and 380 can be stamped or sheared from a metal or metal alloy material sheet in one example. The material sheet can have a thickness “T” in a range between 0.25 mm and 0.75 mm for example. As particular examples, the stiffeners 370 and 380 can be 0.25 mm, 0.35 mm, 0.40 mm, 0.45 mm, 0.5 mm, 0.55 mm, 0.60 mm, 0.65 mm, 0.70 mm, or 0.75 mm in thickness, although other thicknesses can be relied upon. The material sheet can preferably have a relatively high level of stiffness or rigidity and, particularly, higher than that of the material from which the lower housing 302 is formed.

The stiffeners 370 and 380 may be formed as part of a larger leadframe that is stamped or sheared from a metal or metal alloy material sheet. In that case, the stiffeners 370 and 380 can be formed at the same time and as part of the same leadframe, with potentially other stiffeners for other connectors. The leadframe can be placed into a mold, and a plastic or suitable polymer material can be injected into the mold to form the lower housing 302, with the stiffeners 370 and 380 being insert-molded within the lower housing 302. After molding, the stiffeners 370 and 380 can be sheared off and separated from the larger leadframe, at positions outside of the exterior surfaces of the lower housing 302. For example, the side surfaces 372C and 372C of the stiffener 370 can be formed by shearing the stiffener 370 away from the larger leadframe after the lower housing 302 is molded around the leadframe. Similarly, the side surfaces 382C and 382C of the stiffener 380 can be formed by shearing the stiffener 380 away from the larger leadframe after the lower housing 302 is molded around the leadframe. The sheared-off ends of the stiffeners 370 and 380 are also shown in FIGS. 6A-6C. However, in other embodiments, stiffeners and the concepts of structural supports for connector housings can also be assembled into housings for connectors using press- or interference-fits, mechanical interlocks, fasteners, or other arrangements.

As also shown in FIG. 7, the stiffener 370 includes flow-through apertures 373A-373C, and apertures 374A and 375B. The material which forms the lower housing 302 flows through the apertures 373A-373C when the lower housing 302 is formed, which helps to secure the stiffener 370 in place. Additionally, the stiffener 380 includes wafer interlock apertures 383A-383C. The shapes, positions, and number of the wafer interlock apertures 383A-383C can vary as compared to that shown. For example, the stiffener 380 can include a different number of wafer interlock apertures, having a different spacing or at different positions through the stiffener 380 as compared to that shown.

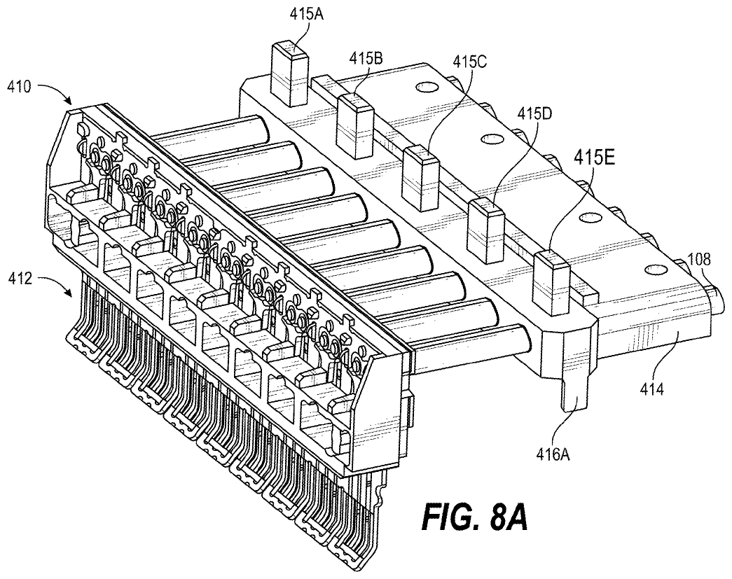

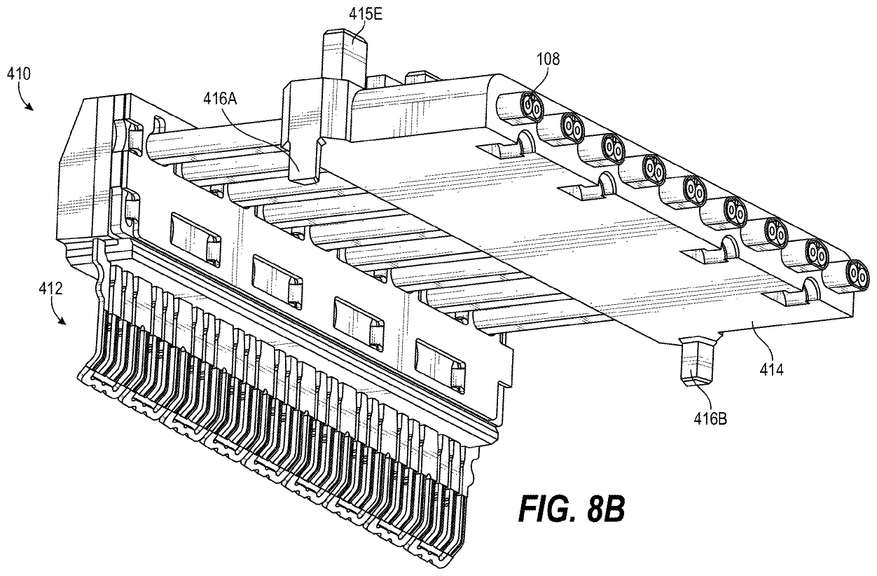

FIG. 8A illustrates a top perspective view of the first wafer assembly 410 shown in FIG. 4, and FIG. 8B illustrates a bottom perspective view of the first wafer assembly 410. The first wafer assembly 410 includes the terminal row 412 and a cable alignment block 414, among other components. The cable alignment block 414 helps to position and align the cable 108, among others, that are terminated at the first wafer assembly 410. The cable 108 can be embodied as a twinaxial cable in one example, including a pair of signal conductors and a ground or common conductor. The signal and ground conductors are electrically coupled to and terminated at the first wafer assembly 410. Electrical signals propagating on the signal conductors are electrically coupled to signal pins or terminals in the terminal row 412. Similarly, the ground conductors are electrically coupled to ground terminals in the terminal row 412.

The cable alignment block 414 includes wafer alignment posts 415A-415E. Corresponding to those alignment posts, the upper housing 304 (see FIG. 3) includes wafer alignment apertures 306B-306E. When the upper housing 304 is assembled over the cable alignment block 414, the wafer alignment posts 415A-415E extend into the wafer alignment apertures 306B-306E, with only a minimal or nominal clearance, if any, between them. The cable alignment block 414 also includes cable block projections 416A and 416B. The cable block projections 416A and 416B of the cable alignment block 414 fit into and interlock with cable alignment channels of the cable alignment block 424, as described below.

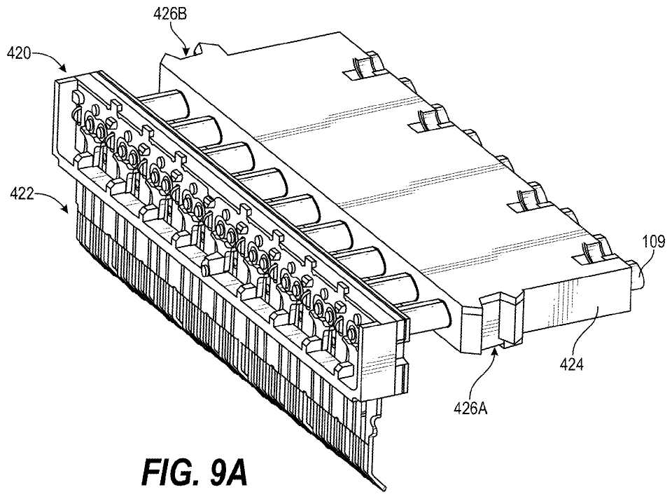

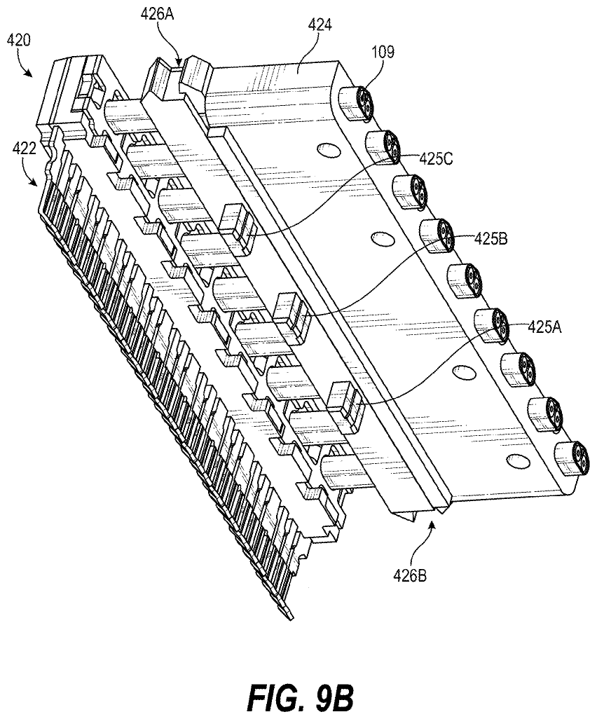

FIG. 9A illustrates a top perspective view of the second wafer assembly 420 shown in FIG. 4, and FIG. 9B illustrates a bottom perspective view of the second wafer assembly 420. The second wafer assembly 420 includes the terminal row 412 and the cable alignment block 424, among other components. The cable alignment block 424 helps to position and align the cable 109, among others, that are terminated at the second wafer assembly 420. The cable 109 can be embodied as a twinaxial cable, in one example, including a pair of signal conductors and a ground or common conductor. The signal and ground conductors are electrically coupled to and terminated at the second wafer assembly 420. Electrical signals propagating on the signal conductors are electrically coupled to signal pins or terminals in the terminal row 422. Similarly, the ground conductors are electrically coupled to ground terminals in the terminal row 422.

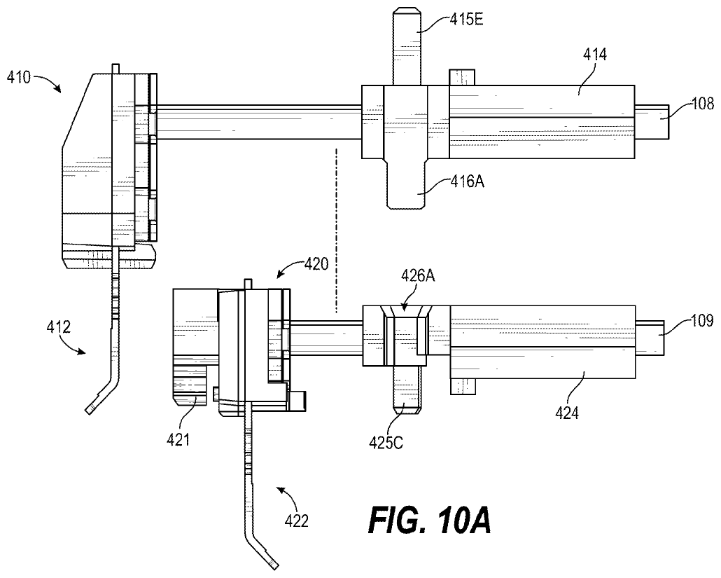

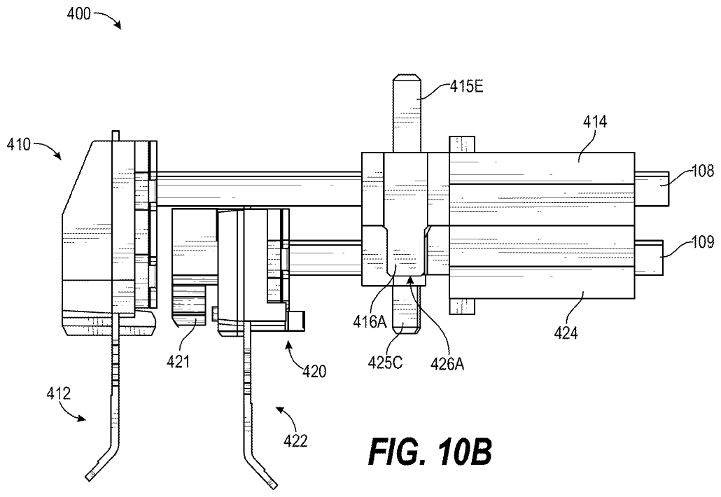

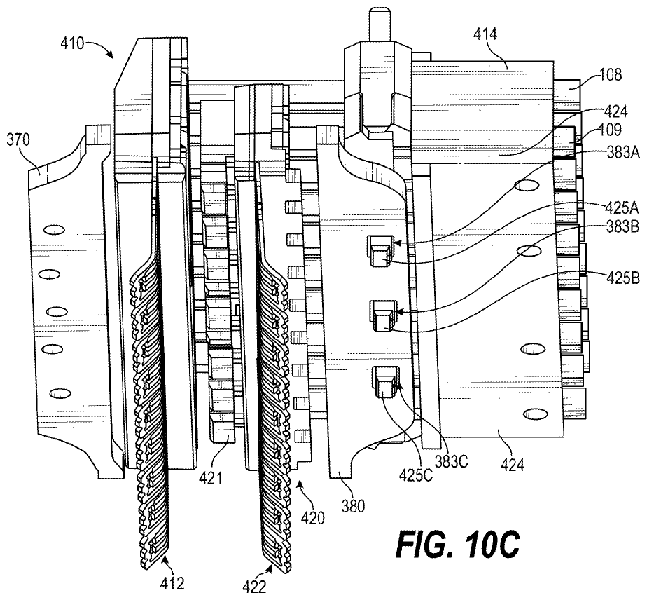

The cable alignment block 424 includes wafer alignment stakes 425A-425C. Corresponding to those alignment stakes, the lower housing 302 (see FIG. 3) includes the wafer interlock apertures 383A-383C, which are formed through the stiffener 380. The wafer alignment stakes 425A-425C extend into the wafer interlock apertures 383A-383C, with only a minimal or nominal clearance, if any, between them, when the plug connector 104 is assembled, as shown in FIG. 10C and the cross-sectional views of FIGS. 11 and 12 and described below. The cable alignment block 424 also includes cable alignment channels 426A and 426B. The cable block projections 416A and 416B of the cable alignment block 414 (see FIGS. 8A and 8B) fit into and interlock with the cable alignment channels 426A and 426B of the cable alignment block 424.

The wafer alignment stakes 425A-425C of the cable alignment block 424 are shown as a representative example in FIG. 9B. The shapes, positions, and number of the wafer alignment stakes 425A-425C can vary as compared to that shown in other embodiments. For example, the cable alignment block 424 can include a different number of wafer alignment stakes, having a different spacing or at different positions on the cable alignment block 424 as compared to that shown.

FIG. 10A illustrates a side view of the first and second wafer assemblies 410 and 420, separated from each other, and FIG. 10B illustrates a side view of the first and second wafer assemblies 410 and 420, assembled together. As best shown in FIG. 10B, the cable block projection 416A of the cable alignment block 414 fits into and interlocks with the cable alignment channel 426A of the cable alignment block 424. Similarly, although not visible in FIGS. 10A and 10B, the cable block projection 416B of the cable alignment block 414 fits into and interlocks with the cable alignment channel 426B of the cable alignment block 424.

FIGS. 10A and 10B also illustrate a wedge 421. The wedge 421 is positioned in front of the second wafer assembly 420 when the plug connector 104 is assembled. After the second wafer assembly 420 is inserted and seated into the lower housing 302 of the plug connector 104, the wedge 421 can also be positioned within the lower housing 302, in front of the second wafer assembly 420. The wedge 421 can help to stabilize and secure the second wafer assembly 420 within the lower housing 302, so that the second wafer assembly 420 does not rock, tilt, or pivot when the plug connector 104 is inserted into the receptacle connector 102. A cross-section of the wedge 421 is also illustrated in FIGS. 11 and 12 and referenced in FIG. 12.

FIG. 10C illustrates a side view of the first and second wafer assemblies 410 and 420, arranged with the stiffeners 370 and 380, according to various embodiments of the present disclosure. Although the lower housing 302 is omitted from view in FIG. 10C, the first and second wafer assemblies 410 and 420 are shown in relation to the stiffeners 370 and 380, as would be the case when the plug connector 104 is assembled. The terminal rows 412 and 422 are positioned between the stiffeners 370 and 380. The cable alignment block 424 includes the wafer alignment stakes 425A-425C. The wafer alignment stakes 425A-425C extend into the wafer interlock apertures 383A-383C of the stiffener 380, with only a minimal or nominal clearance, if any, between them.

FIG. 11 illustrates a cross-sectional view of the plug connector 104 in the connector system 100 shown in FIG. 1 according to various embodiments of the present disclosure. The stiffeners 370 and 380 are substantially coplanar with each other, and the axis “A” extends through the centers of the stiffeners 370 and 380, as shown in FIG. 11.

The first and second wafer assemblies 410 and 420 are shown in relation to the stiffeners 370 and 380 in FIG. 11. The terminal rows 412 and 422 are positioned between the stiffeners 370 and 380. As described herein, the cable alignment block 424 includes the wafer alignment stakes 425A-425C, which extend into the wafer interlock apertures 383A-383C of the stiffener 380, respectively. In FIG. 11, the wafer alignment stake 425B is shown to extend into and through the wafer interlock aperture 383B. The wafer alignment stakes 425A and 425C, similarly, extend into and through the wafer interlock apertures 383A and 383C.

The lower housing 302 includes the interlock seat region 360. The top surface 381 of the stiffener 380 is substantially coplanar with the interlock seat surface 362 (see FIG. 6B) in the interlock seat region 360. The cable alignment block 424 is positioned and seated, in part, in the interlock seat region 360, with the wafer alignment stake 425B extending through the wafer interlock aperture 383B. The cable alignment block 424 rests in part upon the interlock seat surface 362 and in part upon the top surface 381 of the stiffener 380.

Part of the reinforcement truss 342 of the lower housing 302 is also shown in FIG. 11. The reinforcement truss 342 provides additional strength for the sidewalls of the insertion region 302A of the lower housing 302. The reinforcement truss 342 is integrally formed in the insertion region 302A, below the interlock seat region 360 in the lower housing 302.

Additionally, as shown in FIG. 7, the stiffener 370 includes flow-through apertures 373A-373C. The material which forms the lower housing 302 flows through the apertures 373A-373C when the lower housing 302 is formed, which helps to secure the stiffener 370 in place. Thus, FIG. 11 illustrates how the material of the lower housing 302 has been molded through the flow-through aperture 373B. The material is also molded through the flow-through apertures 373A and 373C in a similar way.

FIG. 12 illustrates an enlarged view of part of the cross-sectional view shown in FIG. 11. The top surface 381 of the stiffener 380 is identified in FIG. 12. A first portion 381A of the top surface 381 is covered by the housing material of the lower housing 302. A second portion 381B of the top surface 381 is exposed outside the housing material of the lower housing 302. The cable alignment block 424 is positioned and seated, in part, over or upon the second portion 381B of the top surface 381, as shown in FIG. 11. The wafer alignment stake 425B of the cable alignment block 424 also extends through the wafer interlock aperture 383B of the stiffener 380.

The stiffeners 370 and 380 help to reinforce the lower housing 302 and prevent it from bending or deforming. Because the lower housing 302 is designed to support the plug wafer assembly 400 in a position with relative precision, to the extent possible, any deformation of the lower housing 302 may result in the application of unwanted, undesirable, and unexpected forces being presented on the plug wafer assembly 400, which can result in an unexpected and unwanted loss of signal coupling integrity. Thus, the stiffeners 370 and 380 help to reinforce the lower housing 302 and prevent the loss of signal coupling integrity, even in the presence of various forces applied to it over time.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,”“orthogonal,”“vertex,”“collinear,”“coplanar,”and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

1. An electrical connector, comprising:
a housing comprising a stiffener, a housing material of the housing being molded around the stiffener; and
a wafer assembly comprising a terminal row and a cable alignment block, the cable alignment block being seated in the housing over the stiffener.

2. The electrical connector according to claim 1, wherein:
the cable alignment block comprises a wafer alignment stake;
the stiffener comprises a wafer interlock aperture; and
the wafer alignment stake extends through the wafer interlock aperture.

3. The electrical connector according to claim 1, wherein:
the stiffener comprises a wafer interlock aperture;
the housing comprises a clearance opening; and
the wafer interlock aperture of the stiffener is aligned with the clearance opening of the housing, such that a continuous opening extends through the wafer interlock aperture and the clearance opening.

4. The electrical connector according to claim 3, wherein the clearance opening is larger than the wafer interlock aperture.

5. The electrical connector according to claim 3, wherein:
the cable alignment block comprises a wafer alignment stake; and
the wafer alignment stake extends through the wafer interlock aperture and the clearance opening.

6. The electrical connector according to claim 1, wherein:
the housing comprises a row aperture that extends from a top surface through to a bottom surface of the housing;
the terminal row of the wafer assembly is positioned within the row aperture of the housing;
the stiffener comprises an edge stiffener and a wafer interlock stiffer;
the edge stiffener is molded into the housing at one side of the row aperture and the terminal row; and
the wafer interlock stiffer is molded into the housing at another side of the row aperture and the terminal row.

7. The electrical connector according to claim 1, wherein:
the housing comprises an interlock seat region having an interlock seat surface;
at least a portion of a top surface of the stiffener is exposed within the interlock seat region; and
the interlock seat surface is substantially coplanar with the top surface of the stiffener that is exposed within the interlock seat region.

8. The electrical connector according to claim 1, wherein the stiffener comprises at least one flow-through aperture with the housing material being molded through the flow-through aperture.

9. The electrical connector according to claim 1, wherein the stiffener comprises a first sheared end surface at one side of the housing and a second sheared end surface at another side of the housing.

10. The electrical connector according to claim 1, wherein:
the stiffener comprises a top planar surface and a bottom planar surface;
a first region of the top planar surface is exposed outside of the housing material of the housing; and
a second region of the top planar surface contacts and is covered by the housing material of the housing.

11. An electrical connector, comprising:
a housing comprising a stiffener; and
a wafer assembly comprising a terminal row and a cable alignment block, the cable alignment block being seated in the housing over the stiffener, wherein:
the cable alignment block comprises a wafer alignment stake;
the stiffener comprises a wafer interlock aperture; and
the wafer alignment stake extends through the wafer interlock aperture.

12. The electrical connector according to claim 11, wherein:
the housing comprises a clearance opening; and
the wafer interlock aperture of the stiffener is aligned with the clearance opening of the housing, such that a continuous opening extends through the wafer interlock aperture and the clearance opening.

13. The electrical connector according to claim 12, wherein the wafer alignment stake extends through the wafer interlock aperture and the clearance opening.

14. The electrical connector according to claim 11, wherein:
the housing comprises a row aperture that extends from a top surface through to a bottom surface of the housing;
the terminal row of the wafer assembly is positioned within the row aperture of the housing;
the stiffener comprises an edge stiffener and a wafer interlock stiffer;
the edge stiffener is positioned at one side of the row aperture and the terminal row; and
the wafer interlock stiffer is positioned at another side of the row aperture and the terminal row.

15. The electrical connector according to claim 11, wherein:
the housing comprises an interlock seat region having an interlock seat surface;
at least a portion of a top surface of the stiffener is exposed within the interlock seat region; and
the interlock seat surface is substantially coplanar with the top surface of the stiffener that is exposed within the interlock seat region.

16. The electrical connector according to claim 11, wherein:
the stiffener comprises a top planar surface and a bottom planar surface;
a first region of the top planar surface is exposed outside of the housing; and
a second region of the top planar surface contacts and is covered by the housing.

17. An electrical connector, comprising:
a lower housing;
an upper housing; and
a wafer assembly positioned between the lower housing and the upper housing in the connector, the wafer assembly being seated with a stiffener in the connector, wherein:
the stiffener comprises a wafer interlock aperture; and
a wafer alignment stake of the wafer assembly extends through the wafer interlock aperture.

18. The electrical connector according to claim 17, wherein:
the housing comprises a clearance opening; and
the wafer interlock aperture of the stiffener is aligned with the clearance opening of the housing, such that a continuous opening extends through the wafer interlock aperture and the clearance opening.

19. The electrical connector according to claim 18, wherein the wafer alignment stake extends through the wafer interlock aperture and the clearance opening.

20. The electrical connector according to claim 17, wherein:
the lower housing comprises a row aperture that extends from a top surface through to a bottom surface of the housing;
a terminal row of the wafer assembly is positioned within the row aperture of the lower housing;
the stiffener comprises an edge stiffener and a wafer interlock stiffer;
the edge stiffener is positioned at one side of the row aperture and the terminal row; and
the wafer interlock stiffer is positioned at another side of the row aperture and the terminal row.
